(19) United States
(12) Patent Application Publication
(10) Pub. No.: US 2018/0199507 A1
(43) Pub. Date: Jul. 19, 2018

(54) FLEXIBLE ROTARY CUTTING DEVICE AND METHOD

(71) Applicant: Richard Nevels, Sulphur Springs, AR (US)

(72) Inventor: Richard Nevels, Sulphur Springs, AR (US)

(21) Appl. No.: 15/872,941

(22) Filed: Jan. 16, 2018

Related U.S. Application Data
(60) Provisional application No. 62/446,221, filed on Jan. 13, 2017.

(51) Int. Cl. A01D 34/416

(52) U.S. Cl. CPC A01D 34/4166; A01D 34/4165

(57) ABSTRACT

A flexible rotary cutting device useful for attaching to a rotary drive configured to trim vegetation, particularly a lawn mower. The flexible rotary cutting device includes a cutting head, an attachment mechanism, at least one cutting-filament retention mechanisms, and at least one cutting-filament. At least one cutting-filament may be releasably attached to the at least one cutting-filament retention mechanism. The at least one cutting-filament may be configured to sever vegetation as the cutting head is rotated, and may be positioned such that it is passed through the at least one filament-aperture, and between the first-filament engaging pawl and the second-filament engaging pawl, in such a way that the at least one cutting-filament is engaged and anchored by the first-plurality of teeth and the second-plurality of teeth, and extends radially from the outer flange of the cutting head.

### CROSS-REFERENCE TO RELATED APPLICATION(S)

The present application is related to and claims priority to U.S. Provisional Patent Application No. 62/446,221 filed Jan. 13, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### Technical Field

The present invention relates generally to the field of cutting devices of existing art and more specifically relates to lawnmower blades.

### Related Art

Many homeowners use lawnmowers to cut grass. A lawn mower is a machine utilizing one or more revolving blades to cut a grass surface to an even height. The height of the cut grass is adjustable by the operator, typically by a single master lever, or by a lever or nut and bolt on each of the machine's wheels. Lawn mowers may employ a single blade that rotates about a single vertical axis, or a cutting bar and multiple blade assembly that rotates about a single horizontal axis. Mowing with a standard fixed/solid blade on all types of terrain can cause damage to the blade and the housing. Further, the US Consumer Product Safety Commission reported 80,000 lawnmower accidents per year, resulting in 75 deaths. A fixed blade is sufficient when mowing level grass, however rocky or rough terrain can result in broken blades, projectile objects being thrown, injuries, and more. Replacing or repairing the blades and damage to the housing can be costly and time consuming. An efficient solution is needed.

U.S. Pat. No. 4,086,700 to Kiichi Inada relates to a cutting head for a mower. The described cutting head for a mower includes a cutter for a lawn mower having a rotating disc for mounting on a driving mechanism, the disc having a cavity therein and two openings at diametrically opposite points in the periphery of the disc and opening out of the disc from the cavity.

### SUMMARY OF THE INVENTION

In view of the foregoing disadvantages inherent in the known lawnmower blade art, the present disclosure provides a novel flexible rotary cutting device and method. The general purpose of the present disclosure, which will be described subsequently in greater detail, is to provide a flexible rotary cutting device efficient and effective for use.

A flexible rotary cutting device is disclosed herein. The flexible rotary cutting device is useful for attaching to a rotary drive configured to trim vegetation, particularly a lawn mower. The flexible rotary cutting device includes a cutting head, an attachment mechanism, at least one cutting-filament retention mechanisms, and at least one cutting-filament. The cutting head includes a disk, and outer flange affixed to the disk, a cover affixed to the outer flange, and a rotational axis passing through the center of the disk defining the axis of rotation of the flexible rotary cutting device. The outer flange may circumscribe an inner volume defined within the cutting head. An attachment mechanism is affixed to the cutting head, and serves to enable the cutting head to be releasably attached to the rotary drive. The at least one cutting-filament retention mechanism may include a first-fulcrum cylinder having a first-fulcrum axis affixed to the cutting head, such that the first-fulcrum axis is parallel but not concentric to the rotational axis. A second-fulcrum cylinder having a second-fulcrum axis may be likewise affixed to the cutting head, the second-fulcrum axis also being parallel but not concentric to the rotational axis. The at least one cutting-filament retention mechanism may further include a first-filament engaging pawl pivotably engaging the first-fulcrum cylinder having a first-plurality of teeth, and a second-filament engaging pawl pivotably engaging the second-fulcrum cylinder having a second-plurality of teeth. The second-filament engaging pawl may be positioned opposite the first-filament engaging pawl, such that it mirrors the first-filament engaging pawl. At least one filament-aperture may be disposed within the outer flange of the cutting head.

At least one cutting-filament may be releasably attached to the at least one cutting-filament retention mechanism. The at least one cutting-filament may be configured to sever vegetation as the cutting head is rotated, and may be positioned such that it is passed through the at least one filament-aperture, and between the first-filament engaging pawl and the second-filament engaging pawl, in such a way that the at least one cutting-filament is engaged and anchored by the first-plurality of teeth and the second-plurality of teeth, and extends radially from the outer flange of the cutting head.

According to another embodiment, a method of trimming vegetation is also disclosed herein. The method of trimming vegetation includes firstly, providing the flexible rotary cutting device as described; secondly, coupling the attachment mechanism to the rotary drive; thirdly, inserting the at least one cutting-filament into the at least one cutting-filament retention mechanism; fourthly, rotating the rotary drive in order to rotate the cutting device in tandem with the rotary drive; fifthly, severing vegetation with the at least one cutting-filament as the at least one cutting-filament makes contact with vegetation; and sixthly and optionally, re-inserting the at least one cutting-filament into the at least one cutting-filament retention mechanism as the at least one cutting-filament is consumed.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a flexible rotary cutting device and method, constructed and operative according to the teachings of the present disclosure.

FIG. 1 is a perspective view of the flexible rotary cutting device during an ‘in-use’ condition, according to an embodiment of the disclosure.

FIG. 2 is a perspective view of the flexible rotary cutting device of FIG. 1, according to an embodiment of the present disclosure.

FIG. 3 is a perspective view of the flexible rotary cutting device of FIG. 1, according to an embodiment of the present disclosure.

FIG. 4 is a perspective view of the flexible rotary cutting device of FIG. 1, according to an embodiment of the present disclosure.

FIG. 5 is a flow diagram illustrating a method of use for trimming vegetation, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a lawnmower blade and more particularly to a flexible rotary cutting device and method as used to improve the trimming of vegetation.

Generally, the flexible rotary cutting device provides an attachment to replace fixed blades on all types of lawnmowers with a flexible cutting device. It offers a non-solid blade type for mowing both normal lawns and vegetation over rough and rocky terrain. It affords housing protection for mowing in rough areas to prevent damage to cutting device housing. This prevents the mower blades, including those on push mowers, self-propelled mowers or tractors, from damage. The flexible rotary cutting device reduces the risk of many accidents, hazards, and injuries associated with fixed lawnmower blades.

The flexible rotary cutting device includes a flexible cutting-filament that has sufficient rigidity to sever vegetation, but enough flexibility that the cutting-filament will not sever non-vegetation materials, such as rocks and wood. The housing of the cutting device is preferably constructed of metal with smooth, rounded edges to decrease friction and prevent injury or damage due to collisions with the housing. The device may utilize a variety of flexible cutting-filaments made of nylon, cable, wire, or other suitable material that provides uniform cutting with flexibility when making contact with solid objects, such as rocks, sticks, and other hazards. The attachment may be equipped with any type of commonly used blade attachment type, such as the circular or star-shaped apertures often used in commercial lawnmowers. Some embodiments may include aperture-adapters that may allow a single unit of the flexible rotary cutting device to be used with multiple types of lawnmowers. The cutting-filament can be replaced as needed by the user by simply threading the cutting-filament into the housing of the cutting device. A cutting-filament retention mechanism within the housing allows the cutting-filament to be inserted inwards, but prevents the cutting-filament from moving outwards from the housing, thereby resisting centrifugal forces when the housing is spun at high speed. In this way, the cutting-filament may be reliably retained during use and yet easily replaced when the cutting-filament has been expended.

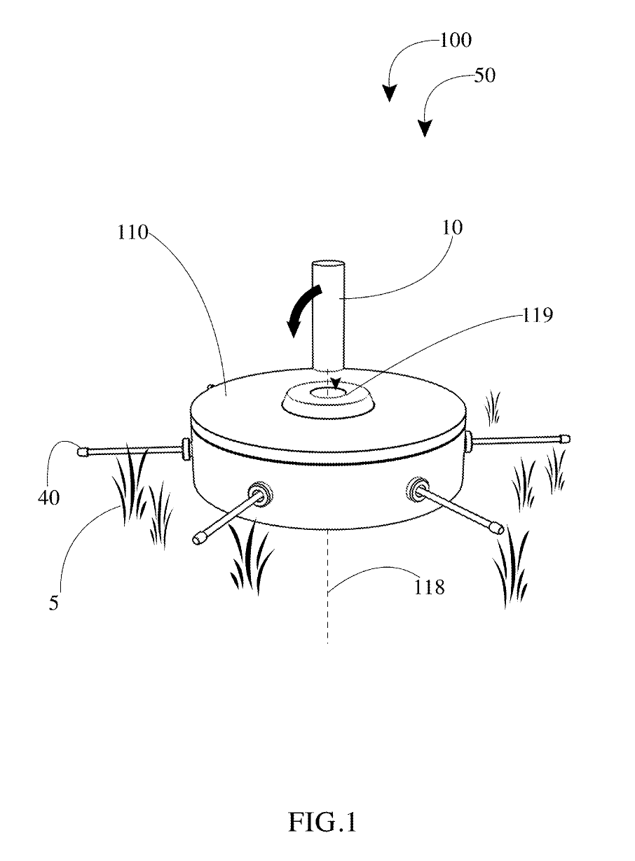

Referring now more specifically to the drawings by numerals of reference, there is shown in FIGS. 1-4, various views of a cutting device 100.

FIG. 1 shows a cutting device 100 during an ‘in-use’ condition 50, according to an embodiment of the present disclosure. Here, cutting device 100 may be beneficial for use by a user 40 to trim vegetation 5. As illustrated, cutting device 100 may be attachable to rotary drive 10, being configured to trim vegetation 5. Attachment mechanism 119 may be affixed to cutting head 110, attachment mechanism 119 enabling cutting head 110 to be releasably attached to rotary drive 10. Attachment mechanism 119 may comprise an aperture configured to receive and circumscribe rotary drive 10. Rotational axis 118 may pass through the center of disk 112, cutting head 110 and rotary drive 10 being rotatable about rotational axis 118 when in use. Upon reading this specification, it should be appreciated that, under appropriate circumstances, considering such issues as user preferences, design preference, structural requirements, marketing preferences, cost, available materials, technological advances, etc., other structural arrangements such as, for example, alternative cutting-filament orientations, cover attachment means, manufacturing methods, etc., may be sufficient.

According to one embodiment, the cutting device 100 may be arranged as a kit 105. In particular, the cutting device 100 may further include a set of instructions 107. The instructions 107 may detail functional relationships in relation to the structure of the cutting device 100 such that the cutting device 100 can be used, maintained, or the like, in a preferred manner.

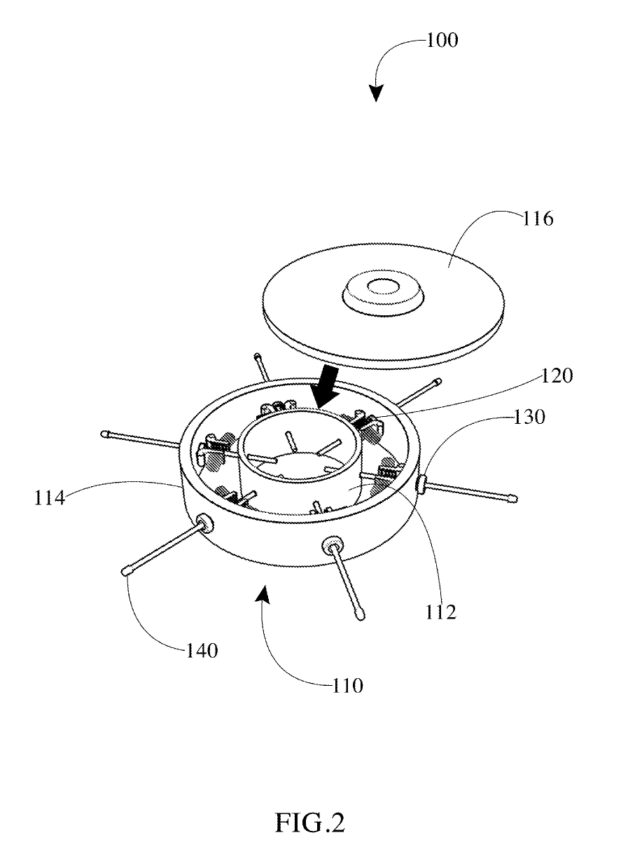

FIG. 2 shows cutting device 100 of FIG. 1, according to an embodiment of the present disclosure. Cutting device 100 may include cutting head 110, at least one cutting-filament retention mechanism 120, at least one filament aperture 130, and at least one cutting-filament 140. Cutting head 110 may include disk 112, outer flange 114, cover 116. Outer flange 114 may be affixed to disk 112, outer flange 114 defining a cylindrical inner volume. Cover 116 may be affixed to outer flange 114, and may be concentric to disk 112. Cover 116 of cutting head 110 may be affixed to disk 112 of cutting head 110 via threaded fasteners. Disk 112 of cutting head 110, outer flange 114 of cutting head 110, and cover 116 of cutting head 110 may be joined with rounded seams. Cutting head 110 may be constructed of metal. At least one cutting-filament retention mechanism 120 may be affixed to cutting head 110. Six of at least one filament retention mechanism(s) may be disposed within cutting head 110, each of at least one filament retention mechanism 120 each being separated by sixty degrees. At least one filament-aperture 130 may be disposed within outer flange 114 of cutting head 110. At least one cutting-filament 140 may be releasably attached to at least one cutting-filament retention mechanism 120, at least one cutting-filament 140 being configured to sever vegetation 5 as cutting head 110 is rotated. At least one cutting-filament 140 may be passed through at least one filament-aperture 130, and between first-filament engaging pawl 126 and second-filament engaging pawl 126, such that at least one cutting-filament 140 extends radially from outer flange 114 of cutting head 110 when attached to at least one cutting-filament retention mechanism 120.

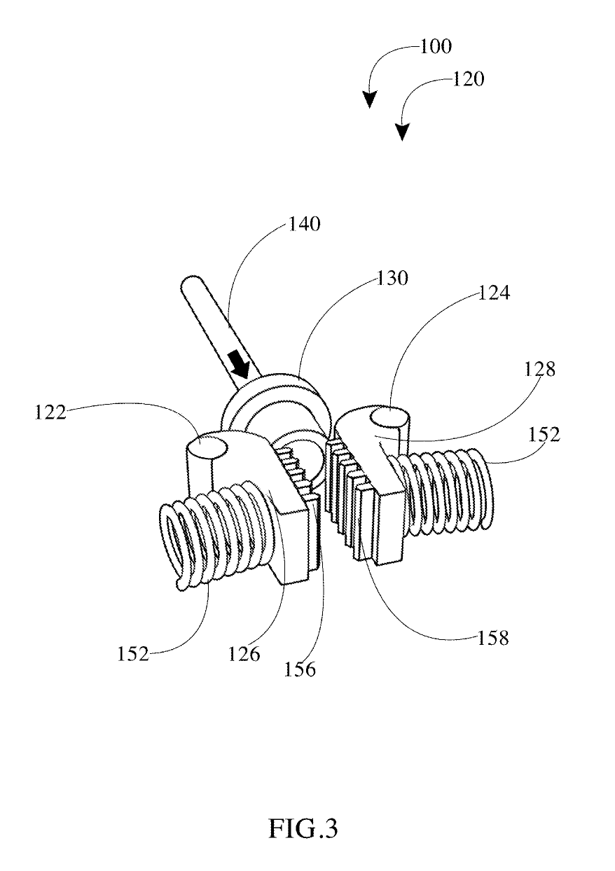

FIG. 3 is a perspective views of cutting device 100 of FIG. 1, according to an embodiment of the present disclosure. At least one cutting-filament retention mechanism 120 may include first-fulcrum cylinder 122, second-fulcrum cylinder 124, first-filament engaging pawl 126, and second-filament engaging pawl 128. First-fulcrum cylinder 122 may have a first-fulcrum axis affixed to cutting head 110, and second-fulcrum cylinder 122 may likewise be affixed to cutting head 110. First-filament engaging pawl 126 may pivotably engage first-fulcrum cylinder 122 and may further include first-plurality of teeth 156 Likewise, second-filament engaging pawl 126 may pivotably engage second-fulcrum cylinder 124, and may have second-plurality of teeth 158, second-filament engaging pawl 126 mirroring first-filament engaging pawl 126. At least one cutting-filament 140 may be engaged and anchored by first-plurality of teeth 156 and second-plurality of teeth 158. At least one cutting-filament 140 may be releasably attached to at least one cutting-filament retention mechanism 120, at least one cutting-filament 140 being passed through at least one filament-aperture 130, and between first-filament engaging pawl 126 and second-filament engaging pawl 126, such that at least one cutting-filament 140 is engaged and anchored by first-plurality of teeth 156 and second-plurality of teeth 158, such that at least one cutting-filament 140 extends radially from outer flange 114 of cutting head 110. First-plurality of teeth 156 of first-filament engaging pawl 126 and second-plurality of teeth 158 of the second-filament may each include five of said teeth. At least one cutting-filament retention mechanism 120 may further includes at least one pawl-spring engaging first-filament engaging pawl 126 and second-filament engaging pawl 126, at least one pawl-spring 152 being configured to push first-filament engaging pawl 126 and second-filament engaging pawl 126 into engagement towards each other. At least one pawl-spring 152 may comprise at least one coil spring.

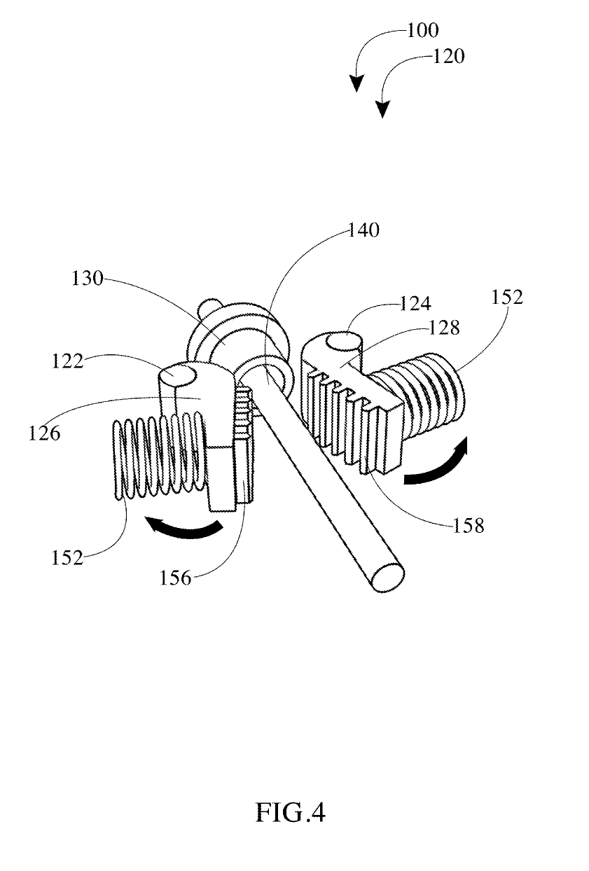

Referring now to FIG. 4 showing a perspective views of cutting device 100 of FIG. 1, according to an embodiment of the present disclosure. As before, at least one cutting-filament retention mechanism 120 may include first-fulcrum cylinder 122, second-fulcrum cylinder 124, first-filament engaging pawl 126, and second-filament engaging pawl 128. At least one pawl-spring 152 is further configured to push first-filament engaging pawl 126 and second-filament engaging pawl 126 into engagement with at least one cutting-filament 140 when at least one cutting-filament 140 is passed between first-filament engaging pawl 126 and second-filament engaging pawl 126. First-plurality of teeth 156 of first-filament engaging pawl 126 mirrors second-plurality of teeth 158 of second-filament engaging pawl 126, first-plurality of teeth 156 of first-filament engaging pawl 126 and second-plurality of teeth 158 of second-filament engaging pawl 126 being disposed towards each other, such that first-plurality of teeth 156 of first-filament engaging pawl 126 and second-plurality of teeth 158 of second-filament engaging pawl 126 engage at least one cutting-filament 140 when at least one cutting-filament 140 is releasably attached to at least one cutting-filament retention mechanism 120.

First-plurality of teeth 156 of first-filament engaging pawl 126 and second-plurality of teeth 158 of second-filament engaging pawl 126 may be angled in a radially outward direction with respect to disk 112 of cutting head 110, first-plurality of teeth 156 of first-filament engaging pawl 126 and second-plurality of teeth 158 of second-filament engaging pawl 126 being configured to resist movement of at least one cutting-filament 140 only in a radially outward direction. Additionally, first-filament engaging pawl 126 and second-filament engaging pawl 126 are pointed away from first-fulcrum cylinder 122 and second-fulcrum cylinder 122 in a radially inward direction with respect to disk 112 of cutting head 110, such that first-filament engaging pawl 126 and second-filament engaging pawl 126 are able to pivot away from each other when at least one cutting-filament 140 is pushed between them from a radially outward direction with respect to disk 112 of cutting head 110, first-plurality of teeth 156 of first-filament engaging pawl 126 and second-plurality of teeth 158 of the second-filament being configured to resist movement of at least one cutting-filament 140 only in said radially outward direction.

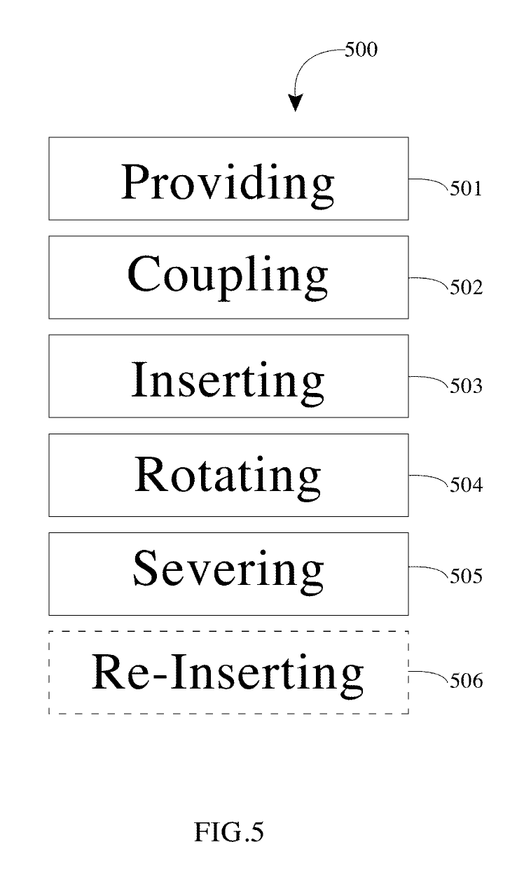

FIG. 5 is a flow diagram illustrating a method for trimming vegetation 500, according to an embodiment of the present disclosure. In particular, the method for trimming vegetation 500 may include one or more components or features of the cutting device 100 as described above. As illustrated, the method for trimming vegetation 500 may include the steps of: step one 501, providing a cutting device attachable to a rotary drive configured to trim vegetation as disclosed; step two 502, coupling the attachment mechanism to the rotary drive; step three 503, inserting the at least one cutting-filament into the at least one cutting-filament retention mechanism; step four 504, rotating the rotary drive in order to rotate the cutting device in tandem with the rotary drive; step five 505, severing vegetation with the at least one cutting-filament as the at least one cutting-filament makes contact with vegetation; and optionally, step six 506, re-inserting the at least one cutting-filament into the at least one cutting-filament retention mechanism as the at least one cutting-filament is consumed.

It should be noted that step 506 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods and means for trimming vegetation, are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A cutting device attachable to a rotary drive configured to trim vegetation, the cutting device comprising:
a cutting head including
a disk,
an outer flange affixed to the disk defining a cylindrical inner volume,
a cover affixed to the outer flange concentric to the disk, and
a rotational axis passing through the center of the disk;
an attachment mechanism affixed to the cutting head for releasably attaching the cutting head to the rotary drive;
at least one cutting-filament retention mechanism including
a first-fulcrum cylinder having a first-fulcrum axis affixed to the cutting head,
the first-fulcrum axis being parallel but not concentric to the rotational axis,
a second-fulcrum cylinder having a second-fulcrum axis affixed to the cutting head, the second-fulcrum axis being parallel but not concentric to the rotational axis,
a first-filament engaging pawl pivotably engaging the first-fulcrum cylinder having a first-plurality of teeth;
a second-filament engaging pawl pivotably engaging the second-fulcrum cylinder having a second-plurality of teeth, the second-filament engaging pawl minoring the first-filament engaging pawl;
at least one filament-aperture disposed within the outer flange of the cutting head; and
at least one cutting-filament releasably attached to the at least one cutting-filament retention mechanism, the at least one cutting-filament being configured to sever vegetation as the cutting head is rotated, the at least one cutting-filament being passed through the at least one filament-aperture, and between the first-filament engaging pawl and the second-filament engaging pawl, such that the at least one cutting-filament is engaged and anchored by the first-plurality of teeth and the second-plurality of teeth, such that the at least one cutting-filament extends radially from the outer flange of the cutting head.

2. The cutting device of claim 1, wherein the at least one filament retention mechanism comprises six of said filament retention mechanisms.

3. The cutting device of claim 2, wherein the six filament retention mechanisms are each separated by sixty degrees.

4. The cutting device of claim 1, wherein the attachment mechanism comprises an aperture configured to receive and circumscribe the rotary drive.

5. The cutting device of claim 1, wherein the cover of the cutting head is affixed to the disk of the cutting head via threaded fasteners.

6. The cutting device of claim 1, wherein the at least one cutting-filament retention mechanism further includes at least one pawl-spring engaging the first-filament engaging pawl and the second-filament engaging pawl, the at least one pawl-spring being configured to push the first-filament engaging pawl and the second-filament engaging pawl into engagement towards each other, the at least one pawl-spring being further configured to push the first-filament engaging pawl and the second-filament engaging pawl into engagement with the at least one cutting-filament when the at least one cutting-filament is passed between the first-filament engaging pawl and the second-filament engaging pawl.

7. The cutting device of claim 6, wherein the first-plurality of teeth of the first-filament engaging pawl mirrors the second-plurality of teeth of the second-filament engaging pawl, the first-plurality of teeth of the first-filament engaging pawl and the second-plurality of teeth of the second-filament engaging pawl being disposed towards each other, such that the first-plurality of teeth of the first-filament engaging pawl and the second-plurality of teeth of the second-filament engaging pawl engage the at least one cutting-filament when the at least one cutting-filament is releasably attached to the at least one cutting-filament retention mechanism.

8. The cutting device of claim 7, wherein the first-plurality of teeth of the first-filament engaging pawl and the second-plurality of teeth of the second-filament engaging pawl are angled in a radially outward direction with respect to the disk of the cutting head, the first-plurality of teeth of the first-filament engaging pawl and the second-plurality of teeth of the second-filament engaging pawl being configured to resist movement of the at least one cutting-filament only in a radially outward direction.

9. The cutting device of claim 7, wherein the first-filament engaging pawl and the second-filament engaging pawl are pointed away from the first-fulcrum cylinder and the second-fulcrum cylinder in a radially inward direction with respect to the disk of the cutting head, such that the first-filament engaging pawl and the second-filament engaging pawl are able to pivot away from each other when the at least one cutting-filament is pushed between them from a radially outward direction with respect to the disk of the cutting head, the first-plurality of teeth of the first-filament engaging pawl and the second-plurality of teeth of the second-filament being configured to resist movement of the at least one cutting-filament only in said radially outward direction.

10. The cutting device of claim 1, wherein the at least one pawl-spring comprises at least one coil spring.

11. The cutting device of claim 1, wherein the at least one pawl-spring comprises at least one leaf spring.

12. The cutting device of claim 1, wherein the cutting device further includes a shield circumscribing the at least one cutting-filament as the cutting device is rotated by the rotary drive, the shield being configured to protect the at least one cutting-filament from contacting rigid materials.

13. The cutting device of claim 1, wherein the cutting device further includes at least one auxiliary cutting device and a linkage operably coupling the at least one auxiliary cutting device to the cutting device, such that the at least one auxiliary cutting device may be operated by the rotary drive in tandem with the cutting device.

14. The cutting device of claim 1, wherein the first-plurality of teeth of the first-filament engaging pawl and the second-plurality of teeth of the second-filament each include five of said teeth.

15. The cutting device of claim 1, wherein the disk of the cutting head, the outer flange of the cutting head, and the cover of the cutting head are joined with rounded seams.

16. The cutting device of claim 1, wherein the cutting head is constructed of metal.

17. A flexible rotary cutting device, the flexible rotary cutting device being attachable to a rotary drive, the flexible rotary cutting device comprising:
a cutting head including
a disk,
an outer flange affixed to the disk defining a cylindrical inner volume,
a cover affixed to the outer flange concentric to the disk, and
a rotational axis passing through the center of the disk;
an attachment mechanism affixed to the cutting head for releasably attaching the cutting head to the rotary drive;
at least one cutting-filament retention mechanism including
a first-fulcrum cylinder having a first-fulcrum axis affixed to the cutting head, the first-fulcrum axis being parallel but not concentric to the rotational axis,
a second-fulcrum cylinder having a second-fulcrum axis affixed to the cutting head, the second-fulcrum axis being parallel but not concentric to the rotational axis,
a first-filament engaging pawl pivotably engaging the first-fulcrum cylinder having a first-plurality of teeth;
a second-filament engaging pawl pivotably engaging the second-fulcrum cylinder having a second-plurality of teeth, the second-filament engaging pawl minoring the first-filament engaging pawl;
at least one filament-aperture disposed within the outer flange of the cutting head; and
at least one cutting-filament releasably attached to the at least one cutting-filament retention mechanism, the at least one cutting-filament being configured to sever vegetation as the cutting head is rotated, the at least one cutting-filament being passed through the at least one filament-aperture, and between the first-filament engaging pawl and the second-filament engaging pawl, such that the at least one cutting-filament is engaged and anchored by the first-plurality of teeth and the second-plurality of teeth, such that the at least one cutting-filament extends radially from the outer flange of the cutting head;
wherein the at least one filament retention mechanism comprises six of said filament retention mechanisms;
wherein the six filament retention mechanisms are each separated by sixty degrees;
wherein the attachment mechanism comprises an aperture configured to receive and circumscribe the rotary drive;
wherein the cover of the cutting head is affixed to the disk of the cutting head via threaded fasteners;
wherein the at least one cutting-filament retention mechanism further includes at least one pawl-spring engaging the first-filament engaging pawl and the second-filament engaging pawl, the at least one pawl-spring being configured to push the first-filament engaging pawl and the second-filament engaging pawl into engagement towards each other, the at least one pawl-spring being further configured to push the first-filament engaging pawl and the second-filament engaging pawl into engagement with the at least one cutting-filament when the at least one cutting-filament is passed between the first-filament engaging pawl and the second-filament engaging pawl;
wherein the first-plurality of teeth of the first-filament engaging pawl mirrors the second-plurality of teeth of the second-filament engaging pawl, the first-plurality of teeth of the first-filament engaging pawl and the second-plurality of teeth of the second-filament engaging pawl being disposed towards each other, such that the first-plurality of teeth of the first-filament engaging pawl and the second-plurality of teeth of the second-filament engaging pawl engage the at least one cutting-filament when the at least one cutting-filament is releasably attached to the at least one cutting-filament retention mechanism;
wherein the first-plurality of teeth of the first-filament engaging pawl and the second-plurality of teeth of the second-filament engaging pawl are angled in a radially outward direction with respect to the disk of the cutting head, the first-plurality of teeth of the first-filament engaging pawl and the second-plurality of teeth of the second-filament engaging pawl being configured to resist movement of the at least one cutting-filament only in a radially outward direction;
wherein the first-filament engaging pawl and the second-filament engaging pawl are pointed away from the first-fulcrum cylinder and the second-fulcrum cylinder in a radially inward direction with respect to the disk of the cutting head, such that the first-filament engaging pawl and the second-filament engaging pawl are able to pivot away from each other when the at least one cutting-filament is pushed between them from a radially outward direction with respect to the disk of the cutting head, the first-plurality of teeth of the first-filament engaging pawl and the second-plurality of teeth of the second-filament being configured to resist movement of the at least one cutting-filament only in said radially outward direction;
wherein the at least one pawl-spring comprises at least one coil spring;
wherein the first-plurality of teeth of the first-filament engaging pawl and the second-plurality of teeth of the second-filament each include five of said teeth;
wherein the disk of the cutting head, the outer flange of the cutting head, and the cover of the cutting head are joined with rounded seams; and
wherein the cutting head is constructed of metal.

18. The cutting device of claim 17, further comprising set of instructions; and
wherein the cutting device is arranged as a kit.

19. A method of trimming vegetation, the method comprising the steps of:
providing a cutting device attachable to a rotary drive configured to trim vegetation, the cutting device comprising a cutting head including a disk, an outer flange affixed to the disk defining a cylindrical inner volume, a cover affixed to the outer flange concentric to the disk, and a rotational axis passing through the center of the disk, an attachment mechanism affixed to the cutting head for releasably attaching the cutting head to the rotary drive, at least one cutting-filament retention mechanism including a first-fulcrum cylinder having a first-fulcrum axis affixed to the cutting head, the first-fulcrum axis being parallel but not concentric to the rotational axis, a second-fulcrum cylinder having a second-fulcrum axis affixed to the cutting head, the second-fulcrum axis being parallel but not concentric to the rotational axis, a first-filament engaging pawl pivotably engaging the first cylinder having a first-plurality of teeth, a second-filament engaging pawl pivotably engaging the second cylinder having a second-plurality of teeth, the second-filament engaging pawl mirroring the first-filament engaging pawl, at least one filament-aperture disposed within the outer flange of the cutting head, and at least one cutting-filament releasably attached to the at least one cutting-filament retention mechanism, the at least one cutting-filament being configured to sever vegetation as the cutting head is rotated, the at least one cutting-filament being passed through the at least one filament-aperture, and between the first-filament engaging pawl and the second-filament engaging pawl, such that the at least one cutting-filament is engaged and anchored by the first-plurality of teeth and the second-plurality of teeth, such that the at least one cutting-filament extends radially from the outer flange of the cutting head;
coupling the attachment mechanism to the rotary drive;
inserting the at least one cutting-filament into the at least one cutting-filament retention mechanism;
rotating the rotary drive in order to rotate the cutting device in tandem with the rotary drive; and
severing vegetation with the at least one cutting-filament as the at least one cutting-filament makes contact with vegetation.

20. The method of claim 19, further comprising the steps of re-inserting the at least one cutting-filament into the at least one cutting-filament retention mechanism as the at least one cutting-filament is consumed.
